(19) United States
(12) Patent Application Publication
(10) Pub. No.: US 2007/0037535 A1
(43) Pub. Date: Feb. 15, 2007

(54) Synchronization method and apparatus for polar modulation signals

(75) Inventor: Koji Harada, Hyogo (JP)

Correspondence Address: Paul D. Greeley;Ohlandt, Greeley, Ruggiero & Perle, L..L.P., 10th Floor, One Landmark Square, Stamford, CT, 06901-2682, US

(73) Assignee: Agilent Technologies, Inc.

(21) Appl. No.: 11/435,648

(22) Filed: May 17, 2006

(30) Foreign Application Priority Data
Jun. 29, 2005 (JP) 2005-189838

(51) Int. Cl. H04B 1/16; H04B 7/00

(52) U.S. Cl. 455/208; 455/502

(57) ABSTRACT

Signals under test that are modulated signals are amplitude-demodulated and amplitude-demodulated signals that are the amplitude component of the signals under test are generated; the signals under test are phase demodulated and phase-demodulated signals that are the phase component of the signals under test are generated; reference amplitude signals and reference phase signals that correspond to the signals under test and synchronize with one another are generated; the amplitude-demodulated signals and the reference amplitude signals are correlated; the phase-demodulated signals and the reference phase signals are correlated; the time difference between the amplitude-demodulated signals and the phase-demodulated signals is obtained based on the correlation results; the time position of the amplitude-demodulated signals and/or phase demodulated signals is independently tuned based on the time difference; and the properties of the signals under test, or the properties of the device under test that outputs the signals under test, are measured based on the amplitude-demodulated signals and phase-demodulated signals whose time position has been tuned.

### FIELD OF THE INVENTION

The present invention relates to technology for synchronization with signals modulated by multiple systems.

### Discussion of the Background Art

In order to synchronize the receiver and the transmitter of a mobile telecommunications system, for instance, a 2.5 G or 3 G mobile telecommunications system, signals for synchronization are sent from the transmitter to the receiver. The signals for this synchronization are also called the synchronization sequence, the training sequence code, and the like. The time position of the signals are examined for synchronization in the receiver (refer to JP Unexamined Patent Application (Kokai) 2002-27,003). The term synchronization means the examination of the time position relationship between one signal and another signal, in other words, it means to learn the time position relationship between one signal and another signal. Alternatively synchronization means to bring the time position relationship between one signal and another signal to a predetermined relationship.

Recently there has been a tendency toward the use of polar modulation in mobile telecommunications systems. Polar modulation is a system whereby the signal points in a signal space are represented by the amplitude component r and the angle component θ (refer to JP Unexamined Patent Application (Kokai) 2004-356,835). The amplitude component is also called the amplitude signal, the absolute value component or the absolute value signal. The angle component is also called the angle signal, the phase component, or the phase signal. In the present specification the amplitude component and the angle component are together referred to as the polar coordinate component or the polar coordinate signal. This polar modulation system can increase the power efficiency of signal amplifiers. Refer to FIG. 1. FIG. 1 is a block diagram showing the concept of the polar coordinate system. A polar coordinate signal generator 110 generates an amplitude component r and a phase component θ from digital data. Signals output from a carrier wave signal source 120 are phase modulated by the phase component θ at a phase modulator 130. The phase-modulated signals are the amplitude modulated by the amplitude component r at a polar coordinate amp 140. The signals that are generated by the polar modulation system in this way are called polar-modulated signals. A variable gain saturation amplifier 143 amplitude modulates the output signals of phase modulator 130 by the amplitude component r at polar coordinate amp 140. Filters 141 and 142 optimize the related signals.

There are times when there is a time lag between the amplitude-modulated component and the phase-modulated component of the signals generated by this polar modulation system. This time lag leads to several problems. For instance, there are cases in which synchronization with polar modulated signals is not possible in devices that measure modulated signals. Moreover, a time lag will produce an error in the measurement results, even if the device for measuring the modulated signals can be synchronized with polar modulated signals.

### SUMMARY OF THE INVENTION

The Present invention provides method and apparatus for synchronization with modulated signals having a time lag between components. The present invention also provides a method and apparatus for measuring the time lag between the components of modulated signals. Furthermore, The present invention provides a measuring method or a measuring apparatus with which the error produced by the time lag between the components of modulated signals is reduced when compared to the prior art.

A measuring method, and in that it comprises a first step for generating each component of the signals under test from signals under test that are modulated signals; for bringing each component to the same time position, and for outputting each component; and a second step for measuring the properties of the signals under test or the properties of the device under test that outputs the signals under test based on each component.

The first step comprises a third step for bringing the portion that corresponds to the same information to one time position and outputting each component. Additionally, the first step comprises a fourth step whereby N number of components is obtained by demodulation of the signals under test by 2 or more respective N number of demodulation systems.

Each component mentioned above is the amplitude component of the signal under test or the phase component of the signal under test.

Optionally, the present invention comprises a step for amplitude demodulating the signals under test that are modulated signals and for generating amplitude-demodulated signals that are the amplitude component of the signals under test; a step for phase demodulating the signals under test and for generating phase-demodulated signals that are the phase component of the signals under test; an step for generating reference amplitude signals and reference phase signals that correspond to the signals under test and synchronize with one another; a step for correlating the amplitude-demodulated signals and the reference amplitude signals; a step for correlating the phase-demodulated signals and the reference phase signals; an step for obtaining the time difference between the amplitude-demodulated signals and the phase-demodulated signals based on the correlation results in the above steps; and a step for individually adjusting the time position of the amplitude-demodulated signals and/or the phase-demodulated signals based on the time difference, and in that by means of this step, the properties of the signals under test or the device under test that outputs the signals under test are measured based on the amplitude-demodulated signals and the phase-demodulated signals whose temporal position has been adjusted.

A method for measuring the time difference, and this method for measuring the time difference comprises a step for amplitude demodulating input signals and generating amplitude-demodulated signals that are the amplitude component of the input signals; a step for phase demodulating the input signals and generating phase-demodulated signals that are the phase component of the input signals; a step for generating reference amplitude signals and reference phase signals that correspond to the input signals and synchronize with one another; a step for correlating the amplitude-demodulated signals and the reference amplitude signals; a step for correlating the phase-demodulated signals and the reference phase signals; and a step for measuring said time difference between amplitude-demodulated signals and phase-demodulated signals based on the results of the correlations.

A method for measuring the time difference, and this method for measuring the time difference comprises a step for amplitude demodulating input signals and for generating amplitude-demodulated signals that are the amplitude component of the input signals; a step for frequency-demodulating the input signals and generating frequency-demodulated signals that are the frequency component of the input signals; a step for generating reference amplitude signals and reference frequency signals that correspond to the input signals and synchronize with one another; a step for correlating the amplitude-demodulated signals and the reference amplitude signals; a step for correlating the frequency-demodulated signals and the reference frequency signals; and a step for measuring said time difference between amplitude-demodulated signals and frequency-demodulated signals based on the results of the correlations.

A method for synchronization with input signals, and in that it comprises a step for amplitude demodulating input signals and generating amplitude-demodulated signals that are the amplitude component of the input signals; a step for phase demodulating the input signals and generating phase-demodulated signals that are the phase component of the input signals; a step for generating reference amplitude signals and reference phase signals that correspond to the input signals and synchronize with one another; a step for correlating the amplitude-demodulated signals and the reference amplitude signals; a step for correlating the phase-demodulated signals and the reference phase signals; a step for obtaining the time difference between the amplitude-demodulated signals and the phase-demodulated signals based on the correlation results of a first and a second correlator; and a step for independently tuning the time position of the amplitude-demodulated signals and/or the phase-demodulated signals based on the time difference.

By means of the tuning step, the time position of the amplitude-demodulated signals and/or the phase-demodulated signals is individually tuned such that the time position of the amplitude-demodulated signals and the phase-demodulated signals is the same.

A method for synchronization with input signals, and in that it comprises a step for demodulating the input signals by two or more different N number of demodulation systems and for obtaining N number of demodulated signals; a step for generating N number of reference signals corresponding to the respective demodulated signals and the input signals; a step for correlating the demodulated signals and the corresponding reference signals and for obtaining N number of correlation results; and a step for bringing the N number of demodulated signals are brought to the same time position based on the N number of correlation results.

A measuring apparatus, and in that it comprises a synchronizing part with which each component of the signals under test that are modulated signals is brought to the same time position and output and a measuring part for measuring the properties of the signals under test or the properties of a device under test that outputs the signals under test based on each of the components.

The synchronizing part preferably brings the portion corresponding to the same data to one time position and outputs each of the components.

By means of the synchronizing part, N number of components are obtained by demodulating the signals under test by the respective system of two or more N number of demodulation systems.

By means of the synchronizing part, the amplitude component of the signals under test and the phase component of the signals under test are generated and the amplitude component and the phase component are output such that the data contained in the amplitude component and the data contained in the phase component have the same time position.

The synchronizing part preferably comprises an amplitude demodulator for amplitude demodulating the signals under test and for generating amplitude-demodulated signals that are the amplitude component of the signals under test; a phase demodulator for phase demodulating the signals under test and for generating phase-demodulated signals that are the phase component of the signals under test; a signal generator for generating reference amplitude signals and reference phase signals that correspond to the signals under test; a first correlator for correlating the amplitude-demodulated signals and the reference amplitude signals; a second correlator for correlating the phase-demodulated signals and the reference phase signals; a measuring device for obtaining the time difference between the amplitude-demodulated signals and the phase-demodulated signals based on the correlation results of the first and the second correlators; and a time position tuner for individually tuning the time position of the amplitude-demodulated signals and/or the phase-demodulated signals based on the time difference, and in that the measuring part measures the properties of the signals under test or the properties of a device under test that outputs the signals under test based on the amplitude-demodulated signals and the phase-demodulated signals whose time position has been tuned.

An apparatus for measuring the time difference between amplitude-demodulated signals and phase-demodulated signals, and the apparatus for measuring the time difference comprises an amplitude demodulator for amplitude demodulating input signals and for generating amplitude-demodulated signals that are the amplitude component of the input signals; a phase demodulator for phase demodulating the input signals and for generating phase-demodulated signals that are the phase component of the input signals; a signal generator for generating reference amplitude signals and reference phase signals that correspond to the input signals and synchronize with one another; a first correlator for correlating the amplitude-demodulated signals and the reference amplitude signals; and a second correlator for correlating the phase-demodulated signals and the reference phase signals; wherein the apparatus measures the time difference based on the results of the correlation.

An apparatus for measuring the time difference between amplitude-demodulated signals and frequency-demodulated signals, and the apparatus for measuring the time difference comprises an amplitude demodulator for amplitude demodulation of input signals and for generating amplitude-demodulated signals that are the amplitude component of the input signals; a phase demodulator for frequency demodulation of input signals and for generating frequency-modulated signals that are the frequency component of the input signals; a signal generator for generating reference amplitude signals and reference frequency signals that correspond to the input signals and synchronize with one another; a first correlator for correlating the amplitude-demodulated signals and the reference amplitude signals; and a second correlator for correlating the frequency-demodulated signals and the reference frequency signals; wherein the apparatus measures the time difference based on the results of the correlation.

A synchronization apparatus, and comprises an amplitude demodulator for amplitude demodulation of input signals and for generating amplitude-demodulated signals that are the amplitude component of the input signals; a phase demodulator, for phase demodulation of the input signals and for generating phase-demodulated signals that are the phase component of the input signals; a signal generator for generating reference amplitude signals and reference phase signals that correspond to the input signals and synchronize with one another; a first correlator for correlating the amplitude-demodulated signals and the reference amplitude signals; a second correlator for correlating the phase-demodulated signals and the reference phase signals; a measuring device for obtaining the time difference between the amplitude-demodulated signals and the phase-demodulated signals based on the correlation results of the first and the second correlators; and a time position tuning device for individually tuning the time position of the amplitude-demodulated signals and/or the phase-demodulated signals based on the time difference.

The time position tuning device individually adjusts the time position of the amplitude-demodulated signals and/or the phase demodulated signals such that the time position of the amplitude-demodulated signals and the phase-demodulated signals is the same.

A synchronization apparatus, and comprises a demodulator for demodulating input signals by 2 or more different N number of demodulation systems and for obtaining N number of demodulated signals; a signal generator for generating N number of reference signals, which correspond to the respective demodulated signals and the input signals; a correlator for correlating the demodulated signals and corresponding reference signals and for obtaining N number of correlation results; and a time position tuner for tuning N number of demodulated signals to the same time position based on the N number of correlation results.

The present invention facilitates synchronization with modulated signals having a time lag between components. For instance, the present invention facilitates synchronization with polar modulated signals having a time lag between the amplitude-modulated component and the phase-modulated component. The present invention also makes it possible to measure the time lag between components of modulated signals.

### BRIEF DESCRIPTION OF THE DRAWINGS

FIG. 1 is a block diagram showing the concept of polar modulation.

FIG. 2 is a block diagram showing the internal structure of electronic measuring apparatus 200.

FIG. 3 is a drawing showing the structure of EDGE burst signals.

FIG. 4A is a drawing showing the waveform of reference amplitude signals S_{Rr}.

FIG. 4B is a drawing showing reference phase signals S_{Rθ}.

FIG. 5 is a block drawing showing the internal structure of electronic measuring apparatus 400.

FIG. 6 is a block drawing showing the internal structure of polar modulator 610.

FIG. 7 is a block drawing showing the internal structure of polar/Orthogonal converter 620.

FIG. 8 is a drawing showing modulated signal generator 800 and electronic measuring apparatus 900.

FIG. 9 is a drawing showing a constellation of EDGE signals.

FIG. 10 is a drawing showing a constellation of EDGE signals.

### DETAILED DESCRIPTION OF THE PREFERRED EMBODIMENT

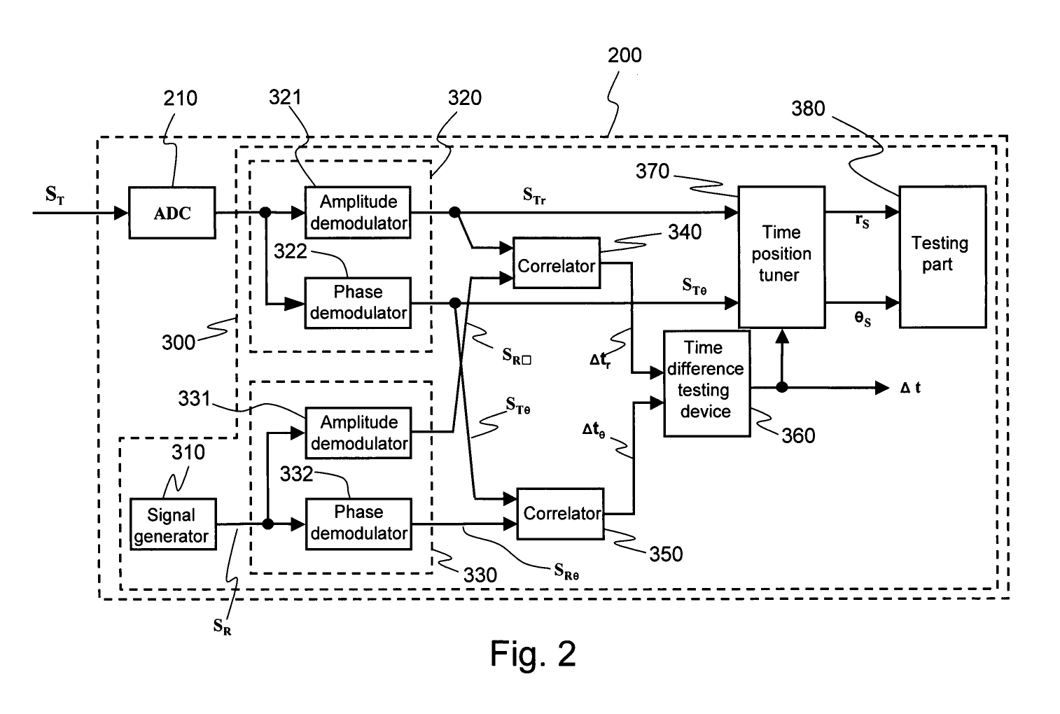

Embodiments of the present invention will now be described while referring to the attached drawings. The first embodiment of the present invention is an electronic measuring apparatus 200 for measuring modulated signals. Refer to FIG. 2. FIG. 2 is a block diagram showing the internal structure of electronic measuring apparatus 200. Electronic measuring apparatus 200 comprises an analog-digital converter 210 and a processor 300. The analog-digital converter is referred to hereafter as an ADC. ADC 210 is the device for analog-digital converting of the signal under test S_{T} and outputting the conversion results to processor 300. Processor 300 is a processor with numeric processing capability, such as a CPU, MPU, RISC, or DSP. As long as it functions in the same way as a CPU and similar devices, processor 300 can also be an FPGA, ASIC, and the like. By executing a program that is not illustrated, processor 300 functions as a signal generator 310, an amplitude/phase decomposer 320, an amplitude/phase decomposer 330, a correlator 340, a correlator 350, a time difference measuring device 360, a time position tuner 370, and a measuring part 380. The parts that are particularly involved in synchronization processing are signal generator 310, amplitude-phase decomposer 320, amplitude/phase decomposer 330, correlator 340, correlator 350, time difference measuring device 360, and time position tuner 370.

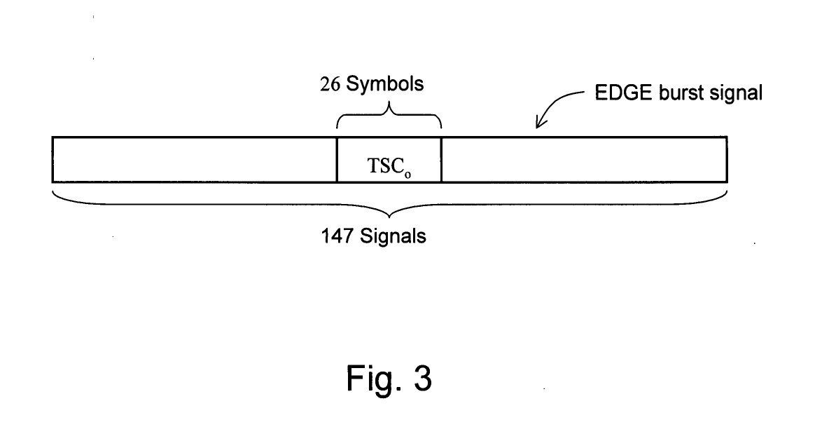

Signal generator 310 is the device for generating reference signals S_{R}. Reference signals S_{R} are signals generated by the same modulation system as the modulation system of the signals under test S_{T}. For instance, when the signals under test S_{T} are generated by a polar modulation system, reference signals S_{R} are generated by a polar modulation system, Orthogonal modulation system, and the like. Moreover, the signals under test S_{T} and the reference signals S_{R} are signals that comprise signals for synchronization, and are, for instance, EDGE signals or GSM signals. By means of the present embodiment, EDGE signals are input as the signals under test S_{T}. Refer to FIG. 3. EDGE signals are transmitted and received in burst units, and one burst is 147 symbols. A series of 26 symbols (78 bits) out of the 147 symbols are assigned for synchronization. Eight fixed patterns (TSC₀ through TSC₇) are prescribed as the data for synchronization. By means of the present embodiment, the signals under test S_{T} are transmitted and received. It should be noted that the bit pattern of TSC₀ is the hex expression of “3F3F9E49FFF3FF3F9E49.” On the other hand, the reference signals S_{R} comprise the same type of symbol pattern TSC₀ as the signals under test S_{T}. Thus, the reference signals S_{R} correspond to the signals under test S_{T} in the symbol portions for synchronization. As cited in JP Unexamined Patent Application (Kokai) 2004-361,170, the signals under test S_{T} can also be demodulated and when necessary, the errors in the demodulation results can be corrected and the demodulation results can be modulated to generate the reference signals S_{R}.

Amplitude/phase decomposer 320 and amplitude/phase decomposer 330 are devices for decomposing the input signals into an amplitude component and a phase component. Amplitude/phase decomposer 320 comprises an amplitude demodulator 321 and a phase demodulator 322 for amplitude/phase decomposition. Amplitude demodulator 321 demodulates amplitude of the signal under test S_{T} that is input to amplitude/phase decomposer 320; it thereby generates an amplitude-demodulated signal S_{Tr}, which is the amplitude component of the signal under test S_{T}; and outputs this amplitude-demodulated signal S_{Tr}. Phase demodulator 322 demodulates phase of the signal under test S_{T}; it thereby generates a phase-demodulated signal S_{Tθ}, which is the phase component of the signal under test S_{T}; and outputs this phase-demodulated signal S_{Tθ}. Amplitude/phase decomposer 330 comprises an amplitude demodulator 331 and a phase demodulator 332 for amplitude/phase resolution. Amplitude demodulator 331 demodulates amplitude of the reference signal S_{R} that is input to amplitude/phase decomposer 330; it thereby generates a reference amplitude signal S_{Rr}, which is the amplitude component of the reference signal S_{R}; and outputs this reference amplitude signal S_{Rr}. Phase demodulator 332 demodulates phase of the reference signal under test S_{R}; it thereby generates a reference phase signal S_{Rθ}, which is the phase component of the reference signal S_{R}; and outputs this reference phase signal S_{Rθ}. Amplitude demodulator 321 and amplitude demodulator 331 are the same demodulation system. Moreover, phase demodulator 322 and phase demodulator 332 are the same demodulation system. Correlators 340 and 350 are the devices for correlating two input signals and outputting the correlation results. Time difference measuring device 360 is the device for measuring the time position relationship between the output signals of correlator 340 and the output signals of correlator 350 and outputting the measurement results. Time position tuner 370 is the device for bringing to the same time position the signals output from amplitude demodulator 321 and the signals output from phase demodulator 322 based on the output signals of time difference measuring device 360. Synchronized amplitude signals rs and synchronized phase signals θs, which are the output signals of time difference tuner 370, are input to measuring part 380. Measuring part 380 tests the properties of the signals under test S_{T}, or of a device under test that is not shown and outputs the signals under test S_{T}, based on the synchronized amplitude signals rs and the synchronized phase signals θs.

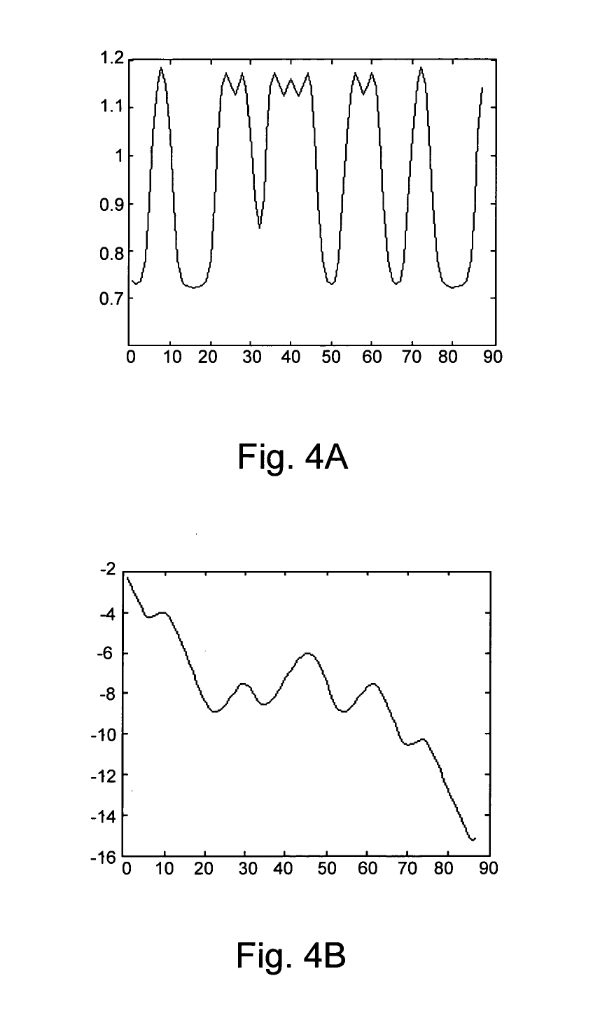

Synchronization with the signals under test S_{T} is performed as follows in electronic measuring apparatus 200 structured as described above. Reference amplitude signals S_{Rr} and reference phase signals S_{Rθ} are generated from reference signals S_{R} by amplitude/phase decomposer 330. By way of reference, FIG. 4A shows the waveform of reference amplitude signals S_{Rr} of the portion corresponding to TSC₀; and FIG. 4B shows the waveform of reference phase signals S_{Rθ} of the portion corresponding to TSC₀. The y-axis in FIGS. 4A and 4B indicates the signal amplitude, and the x-axis indicates time.

Refer to FIG. 2 once again. Amplitude demodulated signal S_{Tr} and the corresponding amplitude signal S_{Rr} are correlated by correlator 340. The output Δtᵣ of correlator 340 shows the time position relationship between the amplitude-demodulated signal S_{Tr} and the reference amplitude signal S_{Rr}. Moreover, the phase-demodulated signal S_{Tθ} and the corresponding reference phase signal S_{Rθ} are correlated by correlator 350. The output Δt_{θ} of correlator 350 shows the time position relationship between the phase-demodulated signals S_{Tθ} and the reference phase signals S_{Rθ}. When the degree of correlation between two input signals is at a maximum, a positive or a negative peak appears in the output signals from correlator 340 or correlator 350, respectively. Time difference measuring device 360 compares the peak of signal Δtᵣ and the peak of signal Δt_{θ}, measures the time difference between the peaks, and outputs the measurement result as a time difference signal Δt. Time position tuner 370 individually shifts amplitude demodulated signals S_{Tr} and/or phase demodulated signals S_{Tθ} forward or backward in terms of time based on time difference signals Δt and brings amplitude-demodulated signals S_{Tr} and phase-demodulated signals S_{Tθ} to the same time position. As a result, the tuner outputs synchronized amplitude signals rₛ and synchronized phase signals θₛ, which are the amplitude component S_{Tr} and the phase component S_{Tθ} of the portion corresponding to TSC₀ that have been brought to the same time position. Synchronized amplitude signals rₛ and synchronized phase signals θs, of course, as a whole are brought to the same time position. Thus, synchronization with the signals under test in measuring part 380 ([transmitted] to measuring part 380) can be facilitated, and the error that is produced in the measurement results due to a time lag between the amplitude component S_{Tr} and the phase component S_{Tθ} can be reduced, by generating the amplitude component S_{Tr} of the signals under test S_{T} and the phase component S_{Tθ} of the signals under test S_{T} that have been brought to the same time position from the signals under test S_{T} that are polar modulated signals.

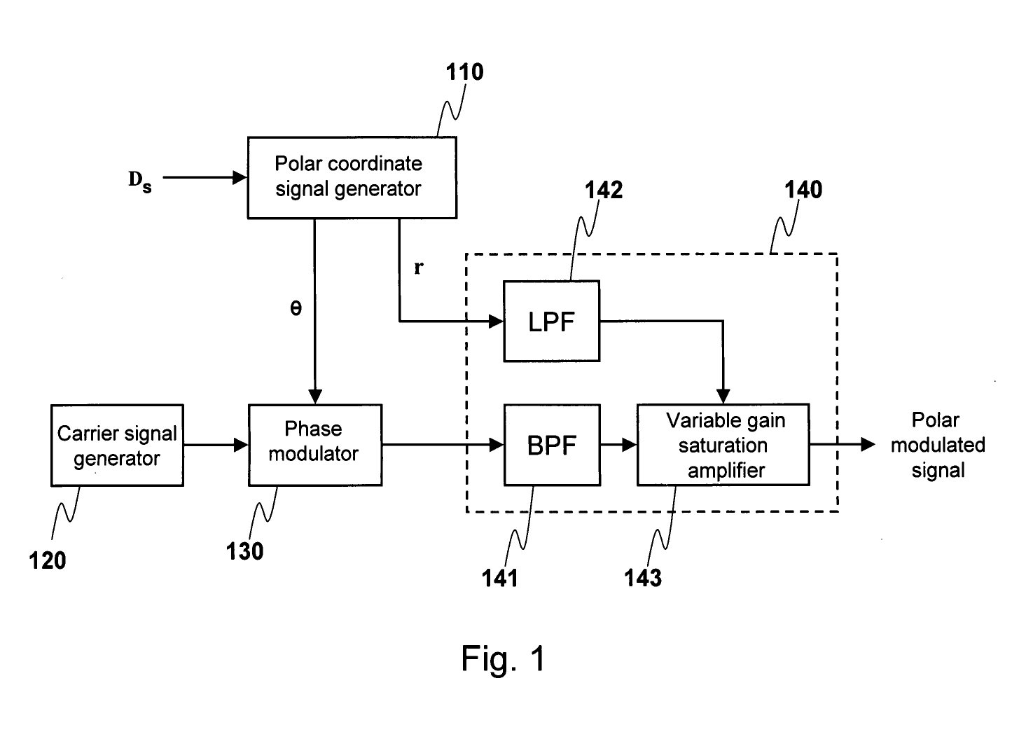

Electronic measuring device 200 obtains the time difference signal Δt in the above-mentioned synchronization. This time difference signal Δt is beneficial to the tuning of polar coordinate amp 140 shown in FIG. 1, in tuning to bring to zero the time lag between the amplitude-modulated component and the phase-modulated component generated during the course of polar modulation.

By means of this first embodiment, reference signals (S_{Rr} and S_{Rθ}) should be synchronized with at least one another and ideally brought to the same time position to correspond to the demodulated signals (S_{Tr} and S_{Tθ}). Consequently, the reference signals (S_{Rr} and S_{Rθ}) can be generated not only from the reference signal S_{R} that is a polar modulated signal, but also from data D_{R}, which is the basis of the reference signal S_{R}. Therefore, a second embodiment with which the reference signals (S_{Rr} and S_{Rθ}) are generated from data D_{R} will now be described.

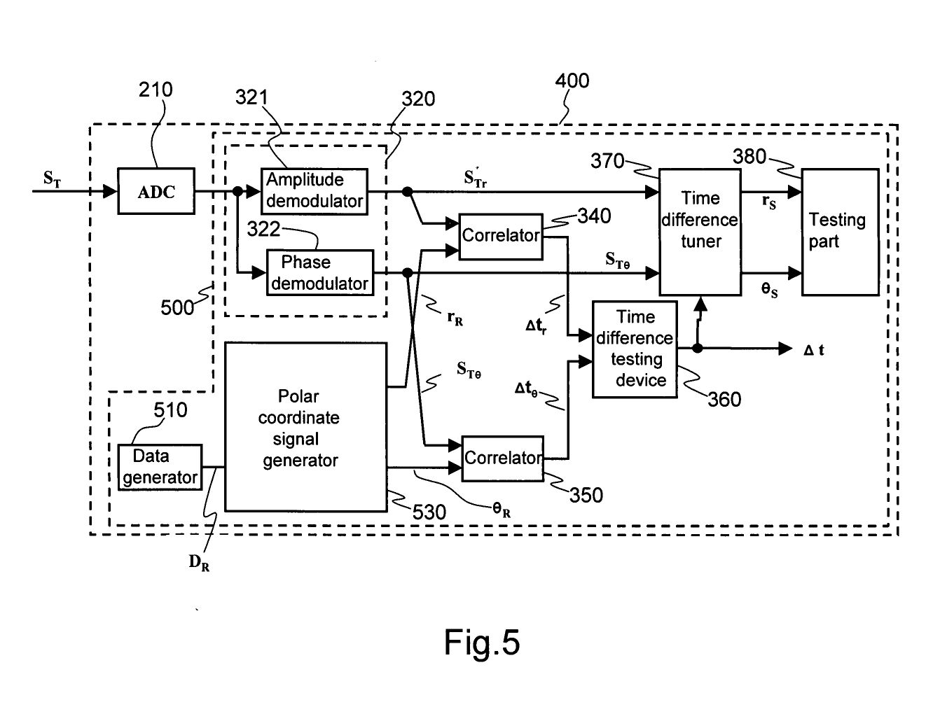

The second embodiment of the present invention is an electronic measuring apparatus 400 for measuring modulated signals. Refer to FIG. 5. FIG. 5 is a block diagram showing the internal structure of electronic measuring apparatus 400. Electronic measuring apparatus 400 comprises ADC 210 and a processor 500. ADC 210 is the device for analog-digital converting the signal under test S_{T} and outputting the conversion results to processor 500. Processor 500 is a processor with numeric processing capability, such as a CPU, MPU, RISC, or DSP. As long as it functions in the same way as a CPU, and similar devices, processor 300 can also be an FPGA, ASIC, and the like. By executing a program that is not illustrated, processor 500 functions as a data generator 510, the amplitude/phase decomposer 320, a polar coordinate signal generator 530, the correlator 340, the correlator 350, the time difference measuring device 360, the time position tuner 370 and the measuring part 380. The parts that are particularly involved in synchronization processing are data generator 510, amplitude/phase decomposer 320, polar coordinate signal generator 530, correlator 340, correlator 350, time difference measuring device 360, and time position tuner 370.

Data generator 510 is the device for generating reference data D_{R}. The reference data D_{R} comprise pattern TSC₀ for synchronization. Polar coordinate signal generator 530 inputs reference data D_{R}. Polar coordinate signal generator 530 is the device for generating signals (r_{R} and θ_{R}), which represent by a polar coordinate system the coordinate in the signal space of the symbols corresponding to reference data D_{R}. For instance, when the coordinates of a certain symbol are (I, Q), polar coordinate signal generator 530 outputs reference amplitude signals r_{R}=√(I²+Q²) and reference phase signals θ_{R}=tan⁻¹(Q/I). These reference amplitude signals R_{R} and reference phase signals θ_{R} are brought to the same time position. Reference amplitude signal r_{R} is applied to correlator 340 in place of reference amplitude signal S_{Rr}. Moreover, reference phase signal θ_{R} is applied to correlator 350 in place of reference phase signal S_{Rθ}. Reference amplitude signal r_{R} is the same as reference amplitude signal S_{Rr}. Reference phase signal θ_{R} is the same as reference phase signal S_{Rθ}.

Synchronization with the signals under test S_{T} is performed as described below in the electronic measuring device 400 constructed as described above. The amplitude demodulated signal S_{Tr} and the corresponding reference amplitude signal r_{R} are correlated by correlator 340. Output Δtᵣ of correlator 340 shows the time position relationship between the amplitude-demodulated signal S_{Tr} and the reference amplitude signal r_{R}. Moreover, phase-demodulated signal S_{Tθ} and corresponding reference phase signal θ_{R} are correlated by correlator 350. Output Δt_{θ} of correlator 350 shows the time position relationship between the phase-demodulated signal S_{Tθ} and the reference phase signal θ_{R}. When the degree of correlation between two input signals is at a maximum, a positive or a negative peak appears in the output signals from correlator 340 or correlator 350, respectively. Time difference measuring device 360 compares the peak of signal Δtᵣ and the peak of signal Δt_{θ}, measures the time difference between the peaks, and outputs the measurement results as the time difference signal Δt. Time position tuner 370 individually shifts amplitude-demodulated signals S_{Tr} and/or phase-demodulated signals S_{Tθ} forward or backward in terms of time based on the time difference signals Δt and brings the amplitude-demodulated signals S_{Tr} and the phase-demodulated signals S_{Tθ} to the same time position. As a result, the tuner outputs synchronized amplitude signals rₛ and synchronized phase signals θₛ, which are the amplitude component S_{Tr} and the phase component S_{Tθ} of the portion corresponding to TSC₀ that have been brought to the same time position. Synchronized amplitude signals rₛ and synchronized phase signals θₛ, of course, as a whole are brought to the same time position. Thus, synchronization with the signals under test in measuring part 380 ([transmitted] to measuring part 380) can be facilitated, and the error that is produced in the measurement results due to a time lag between the amplitude component S_{Tr} and the phase component S_{Tθ} can be reduced, by generating the amplitude component S_{Tr} of the signals under test S_{T} and the phase component S_{Tθ} of the signals under test S_{T} that have been brought to the same time position from the signals under test S_{T} that are polar modulated signals.

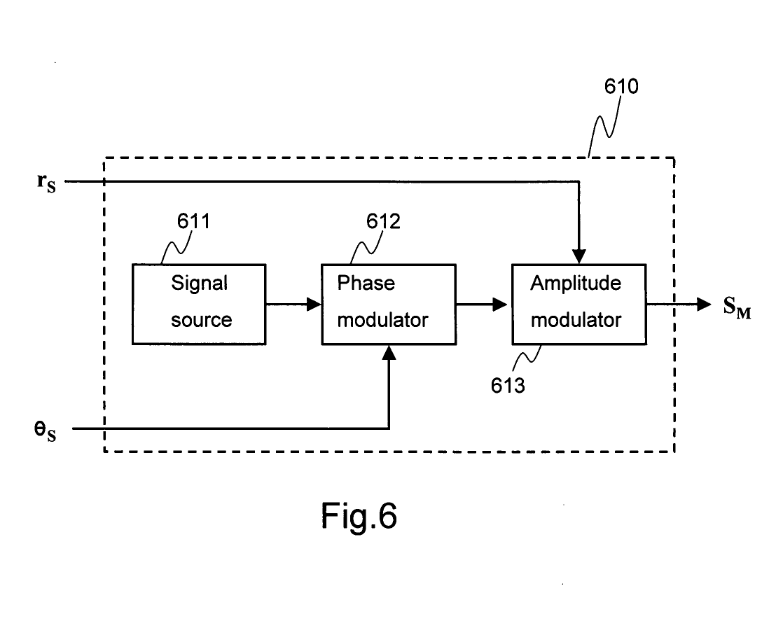

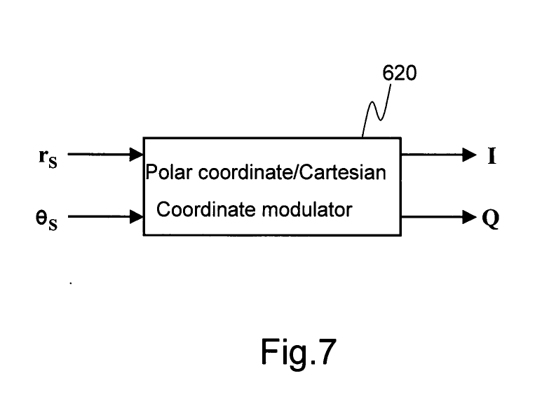

By means of the first and second embodiments, synchronized amplitude signals rₛ and synchronized phase signals θₛ can be converted to another signal format. For instance, a polar modulator 610 can be housed inside or be disposed in front of the input step of measuring part 380 in order to obtain polar modulated signals from synchronized amplitude signals rₛ and synchronized phase signals θ_{S}. Moreover, a polar coordinate/Orthogonal coordinate converter 620 can be housed inside or be disposed in front of the input step of measuring part 380 in order to obtain Orthogonal signals (I, Q) from synchronized amplitude signals rₛ and synchronized phase signals θ_{S}. Polar modulator 610 and polar coordinate/Orthogonal coordinate converter 620 have the following structure. Refer to FIG. 6. Polar modulator 610 comprises a signal generator 611, a phase modulator 612, and an amplitude modulator 613. The signals output from signal source 611 are phase modulated by synchronized phase signals θₛ at phase modulator 612, and are further amplitude modulated by synchronized amplitude signals rₛ at amplitude modulator 613 to generate polar modulated signals S_{M}. It should be noted that the frequency of the signals output from signal source 611 is 0 Hz or higher. When the output signal frequency of signal source 611 is 0 Hz, the frequency of the output signals is kept low and this facilitates post-processing. Next, refer to FIG. 7. Polar coordinate/Orthogonal coordinate converter 620 generates in-phase signals I and Quadrature signals Q from input synchronized amplitude signals rₛ and synchronized phase signals θₛ based on I=r_{S}·cos(θₛ) and Q=rₛ·sin(θₛ). There are advantages to the above-mentioned conversion in that it can be used with conventional measuring apparatuses, etc.

By means of the first and second embodiments, the amplitude component and the phase component were each correlated in order to obtain the time difference, but it is possible to correlate the amplitude component and the frequency component. This is because phase modulation and frequency modulation are also referred to together as angle modulation and have properties that can be converted between them. For instance, phase demodulator 322 and phase demodulator 332 can be changed to frequency modulators in FIG. 2. Moreover, phase demodulator 322 in FIG. 5 can be changed to a frequency demodulator, and a differentiator can be inserted between polar coordinate signal generator 530 and correlator 350. As a result of these changes, a frequency demodulated signal S_{Tf} (not illustrated) is obtained by frequency demodulation of the signal under test S_{T} and a reference frequency signal S_{Rf} (not illustrated) is obtained by frequency demodulation of reference signals S_{R}. Reference frequency signals f_{R} (=S_{Rf}) are obtained by differentiation of the output of polar coordinate signal generator 530. Moreover, frequency demodulated signal S_{Tf} and reference frequency signal S_{Rf} or f_{R} are correlated in place of the correlation with respect to the phase component. Finally, when the time position of the peak of the correlation results relating to the amplitude component and the time position of the peak of the correlation results relating to the frequency component are compared, a time difference signal Δt is obtained. The resulting time difference signal Δt can be used to tune the time position between amplitude-demodulated signals S_{Tr} and phase-demodulated signals S_{Tθ}. However, in this case, it is necessary to generate phase-demodulated signals S_{Tθ} separately from the signals under test S_{T} and to generate phase-demodulated signals S_{Tθ} from the above-mentioned frequency-demodulated signals S_{Rf} or f_{R}.

With respect to the first embodiment, the reference amplitude signal S_{Rr} and the reference phase signal S_{Rθ} in FIG. 2 are brought to the same time position, but if they are synchronized with one another, that is, if their time position relationship is clear, it is also possible for the reference amplitude signal S_{Rr} and the reference phase signal S_{Rθ} to have different time positions. In this case, the time lag between the reference amplitude signal S_{Rr} and the reference phase signal S_{Rθ} is added or subtracted when the time difference signal Δt is generated, or is added to or subtracted from the time difference signal Δt at time position tuner 370, and applied to measuring part 380. In this case, the measurements conducted by measuring part 380 take into consideration the time lag between the reference amplitude signal S_{Rr} and the reference phase signal S_{Rθ}. This is the same for the reference amplitude signal r_{R} and the reference phase signal θ_{R} in FIG. 5 relating to the second embodiment. The reference amplitude signal r_{R} and the reference phase signal θ_{R} are brought to the same time position, but if they are synchronized, that is, if their time position relationship is clear, the reference amplitude signal r_{R} and the reference phase signal θ_{R} can be at different time positions.

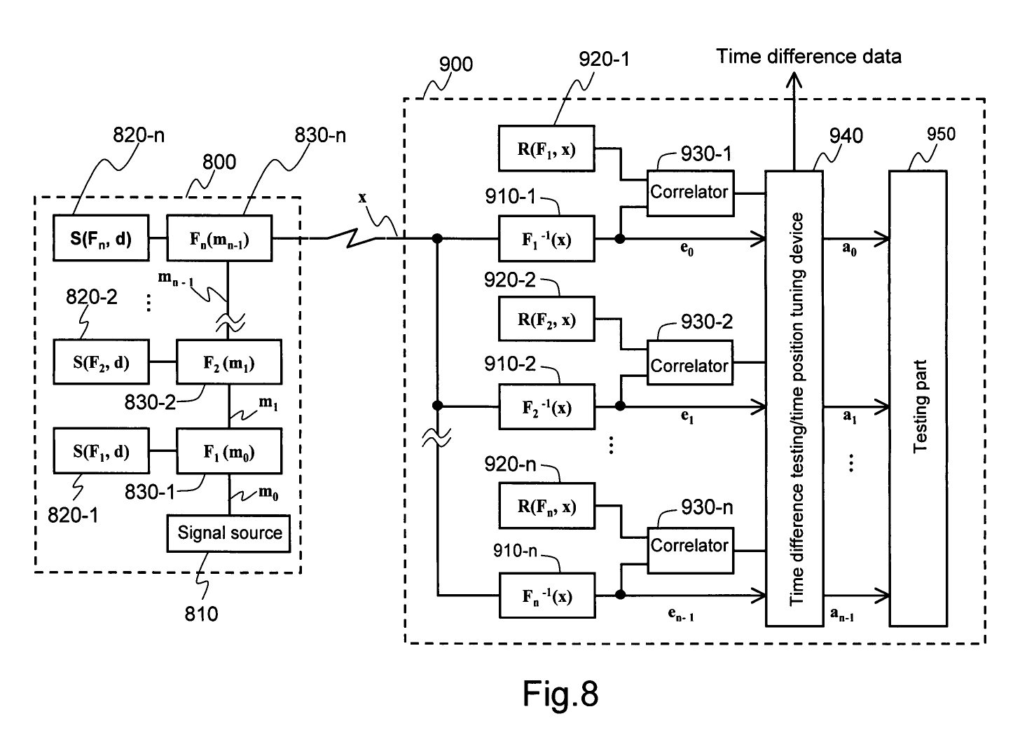

The present invention can be enhanced as follows. This enhanced example is described below as the third embodiment. Refer to FIG. 8. FIG. 8 is a drawing showing a modulated signal generator 800 and an electronic measuring apparatus 900. Electronic measuring apparatus 900 synchronizes with the signals generated by demodulated signal generator 800. Demodulated signal generator 800 comprises a signal source 810 that generates carrier waves, n number of signal sources (820-1 to n), and n number of modulators (830-1 to n). Signal sources (820-1 to n) are devices that generate signals S (F₁ through Fₙ, d) based on the related modulation systems (F₁ through Fₙ) and transmission data d. Transmission and reception data d include data that form the reference for the time position, and include data such that the time position relationship between signals generated by signal sources (820-1 to n) is clear. Modulators (830-1 to n) use modulation systems that will not interfere with one another. The phrase “will not interfere with one another” means that, for instance, the signals that modulator (830-1) allows to ride on the carrier are not affected by the other modulator (830-2), and only signals corresponding to signal S (F₁, d) can be demodulated by the demodulation system that is paired up with the modulation system of modulator (830-1). Output signals m₀ of signal source 810 are modulated in succession by modulators (830-1 to n) and sent to electronic measuring apparatus 900. m₁, m₂, . . . mₙ₋₁ show the output signals of modulators 830-1, 830-2, . . . 830-(n-1), respectively. It should be noted that signal sources (820-1 to n) can be replaced by a signal generator that performs 1 to n functions. Similarly, modulators (830-1 to n) can be replaced by a modulator that performs 1 to n functions.

Electronic measuring apparatus 900 comprises n number of demodulators (910-1 to n), n number of reference signal generators (920-1 to n), n number of correlators (930-1 to n), a time difference measuring/time position tuning device 940, and a measuring part 950. Each of demodulators (910-1 to n) performs demodulation by a system that is paired up with the modulation system of modulators (430-1 to n), respectively. That is, F₁⁻¹ to Fₙ⁻¹ form pairs with the respective F₁ to Fₙ. Demodulators (910-1 to n) output demodulated signals eₒ through eₙ, which are the demodulation results. Demodulated signals eₒ through eₙ represent each component of the signal under test x, which is a modulated signal. Reference signal sources (920-1 through n) generate reference signals R (F₁ through Fₙ, x) corresponding to the respective modulation system of related modulators (910-1 through n) and signal under test x. Reference signals R (F₁ through Fₙ, x) are synchronized with one another. Each correlator (930-1 through n) correlates output signals eₒ through eₙ of related demodulators (910-1 through n) and related reference signals R (F₁ through Fₙ, x). Time difference measuring/time position tuning device 940 measures the time difference between the output signals of each demodulator (910-1 through n) based on the correlation results of each correlator (930-1 through n) and outputs the measurement results. In the figure, the time difference data output from time difference measuring/time position tuning device 940 are output in the form of the time difference data between signals in groups of a maximum of nC₂. Moreover, time difference measuring/time position tuning device 940 brings demodulated signals eₒ through eₙ to the same time position based on the correlation results of each correlator (930-1 through n). As in the first and second embodiments, the portion corresponding to the same data is used for tuning of the time position. Moreover, time difference measuring/time position tuning device 940 outputs synchronized signals aₒ through aₙ, which are signals eₒ through eₙ that have been brought to the same time position. At least one of demodulated signals eₒ through eₙ is individually shifted forward or backward in terms of time inside time difference measuring/time position tuning device 940. Finally, measuring part 950 measures the properties of the signal under test x, or the properties of modulated signal generator 800 that outputs the signal under test x, based on synchronization signals aₒ through aₙ. Demodulators (910-1 through n) can be replaced with demodulators that have 1 though n functions. Similarly, reference signal sources (920-1 through n) can also be replaced by signal generators having 1 through n functions. Moreover, correlators (930-1 through n) can be replaced by correlators having 1 through n functions.

By means of the first and second embodiments, the signal under test S_{T} is processed using a processor and software once the analog-digital conversion is completed, but it is also possible to process a part or all of the portion to be processed using hardware. In this case, ADC 210 may be unnecessary or disposed in a separate place, or a separate ADC may be necessary. Similarly, the signals can be processed by hardware and/or software in the third embodiment.

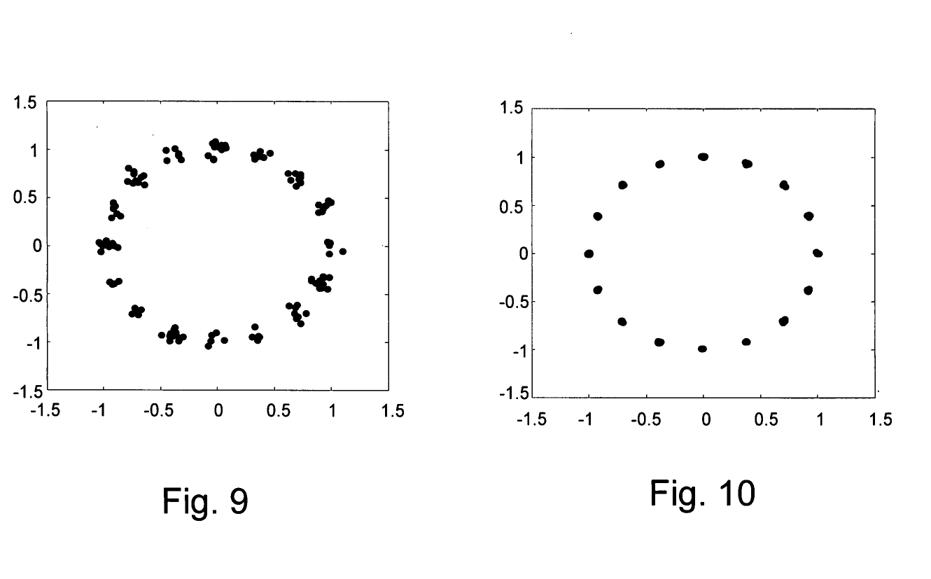

Finally, the effect of the present invention will be illustrated. Refer to FIGS. 9 and 10. Both figures show a constellation of EDGE signals. FIG. 9 shows the measurement results when a conventional synchronization method was used. FIG. 10 shows the measurement results when the synchronization method of the present invention was used. As is clear from FIG. 10, the vector error from the ideal constellation point is reduced by the present invention when compared to the conventional method. Thus, it is possible to determine, for instance, whether or not deterioration of modulation accuracy is due to a polar amplifier.

What is claimed is:

1. A measuring method comprising:
a first step for generating each component of the signals under test from signals under test that are modulated signals; for bringing each component to the same time position, and for outputting each component; and
a second step for measuring the properties of the signals under test or the properties of the device under test that outputs the signals under test based on each component.

2. The measuring method according to claim 1, wherein said first step comprises a third step for bringing the portion that corresponds to the same information to one time position and outputting each component.

3. The measuring method according to claim 1, wherein said first step comprises a fourth step whereby at least 2 N number of components is obtained by demodulation of the signals under test by respective N number of demodulation systems.

4. The measuring method according to claim 1, wherein each said component is the amplitude component of the signal under test or the phase component of the signal under test.

5. The measuring method according to claim 1, further comprising:
a sixth step for amplitude demodulating the signals under test that are modulated signals and for generating amplitude-demodulated signals that are the amplitude component of the signals under test;
a seventh step for phase demodulating the signals under test and for generating phase-demodulated signals that are the phase component of the signals under test;
an eighth step for generating reference amplitude signals and reference phase signals that correspond to the signals under test and synchronize with one another;
a ninth step for correlating the amplitude-demodulated signals and the reference amplitude signals;
a tenth step for correlating the phase-demodulated signals and the reference phase signals;
an eleventh step for obtaining the time difference between the amplitude-demodulated signals and the phase-demodulated signals based on the correlation results in the ninth and tenth steps; and
a twelfth step for individually adjusting the time position of the amplitude-demodulated signals and/or the phase-demodulated signals based on the time difference,
and wherein by means of the twelfth step, the properties of the signals under test or the device under test that outputs the signals under test are measured based on the amplitude-demodulated signals and the phase-demodulated signals whose temporal position has been adjusted.

6. A method for measuring the time difference between amplitude-demodulated signals and phase-demodulated signals, said method comprising:
amplitude-demodulating an input signals and generating amplitude-demodulated signals that are the amplitude component of the input signals;
phase-demodulating said input signals and generating phase-demodulated signals that are the phase component of the input signals;
generating reference amplitude signals and reference phase signals that correspond to the input signals and synchronize with one another;
correlating the amplitude-demodulated signals and the reference amplitude signals;
correlating the phase-demodulated signals and the reference phase signals; and
measuring said time difference based on the results of said correlations.

7. A method for measuring the time difference between amplitude-demodulated signals and phase-demodulated signals, said method comprising:
amplitude-demodulating an input signals and for generating amplitude-demodulated signals that are the amplitude component of the input signals;
frequency-demodulating the input signals and generating frequency-demodulated signals that are the frequency component of the input signals;
generating reference amplitude signals and reference frequency signals that correspond to the input signals and synchronize with one another;
correlating the amplitude-demodulated signals and the reference amplitude signals;
correlating the frequency-demodulated signals and the reference frequency signals; and
measuring said time difference based on the results of said correlations.

8. A synchronization method for synchronization with input signals, said method comprising:
amplitude-demodulating said input signals and generating amplitude-demodulated signals that are the amplitude component of the input signals;
phase-demodulating the input signals and generating phase-demodulated signals that are the phase component of the input signals;
generating reference amplitude signals and reference phase signals that correspond to the input signals and synchronize with one another;
correlating the amplitude-demodulated signals and the reference amplitude signals;
correlating the phase-demodulated signals and the reference phase signals;
obtaining the time difference between the amplitude-demodulated signals and the phase-demodulated signals based on the correlation results of said correlations; and
independently tuning the time position of the amplitude-demodulated signals and/or the phase-demodulated signals based on the time difference.

9. The synchronization method according to claim 8, wherein the time position of the amplitude-demodulated signals and/or the phase-demodulated signals is individually tuned such that the time position of the amplitude-demodulated signals and the phase-demodulated signals is the same.

10. A method for synchronization with input signals, said method comprising:
demodulating the input signals by two or more different N number of demodulation systems and for obtaining N number of demodulated signals;
generating N number of reference signals corresponding to the respective demodulated signals and the input signals;
correlating the demodulated signals and the corresponding reference signals and for obtaining N number of correlation results; and
bring the N number of demodulated signals to the same time position based on the N number of correlation results.

11. A measuring apparatus which comprises:
a synchronizing part with which each component of the signals under test that are modulated signals is brought to the same time position and output; and
a measuring part for measuring the properties of the signals under test or the properties of a device under test that outputs the signals under test based on each of the components.

12. The measuring apparatus according to claim 11, wherein the synchronizing part brings the portion corresponding to the same data to one time position and outputs each of the components.

13. The measuring apparatus according to claim 11, wherein at least 2 N number of components are obtained by demodulating the signals under test by the respective system of N number of demodulation systems.

14. The measuring apparatus according to claim 11, wherein synchronizing generates part the amplitude component of the signals under test and the phase component of the signals under test and outputs the amplitude component and the phase component such that the data contained in the amplitude component and the data contained in the phase component have the same time position.

15. The measuring apparatus according to claim 11, wherein said synchronizing part comprises:
an amplitude demodulator for amplitude demodulating the signals under test and for generating amplitude-demodulated signals that are the amplitude component of the signals under test;
a phase demodulator for phase demodulating the signals under test and for generating phase-demodulated signals that are the phase component of the signals under test;
a signal generator that generates reference amplitude signals and reference phase signals that correspond to the signals under test;
a first correlator that correlates the amplitude-demodulated signals and the reference amplitude signals;
a second correlator that correlates the phase-demodulated signals and the reference phase signals;
a measuring device that obtains the time difference between the amplitude-demodulated signals and the phase-demodulated signals based on the correlation results in the first and the second correlators; and
a time position tuner that individually tuning the time position of the amplitude-demodulated signals and/or the phase-demodulated signals based on the time difference,
and in that the measuring part tests the properties of the signals under test or the properties of a device under test that outputs the signals under test based on the amplitude-demodulated signals and the phase-demodulated signals whose time position has been tuned.

16. An apparatus for measuring the time difference between amplitude-demodulated signals and phase-demodulated signals, said apparatus comprising:
an amplitude demodulator for amplitude demodulating input signals and for generating amplitude-demodulated signals that are the amplitude component of the input signals;
a phase demodulator for phase demodulating the input signals and for generating phase-demodulated signals that are the phase component of the input signals;
a signal generator that generates reference amplitude signals and reference phase signals that correspond to the input signals and synchronize with one another;
a first correlator that correlates the amplitude-demodulated signals and the reference amplitude signals; and
a second correlator that correlates the phase-demodulated signals and the reference phase signals;
wherein said apparatus measures said time difference based on the correlation results in said correlators.

17. An apparatus for measuring the time difference between amplitude-demodulated signals and phase-demodulated signals, said apparatus comprising:
an amplitude demodulator for amplitude demodulation of input signals and for generating amplitude-demodulated signals that are the amplitude component of the input signals;
a frequency demodulator for frequency demodulation of input signals and for generating frequency-modulated signals that are the frequency component of the input signals;
a signal generator that generates reference amplitude signals and reference frequency signals that correspond to the input signals and synchronize with one another;
a first correlator that correlates the amplitude-demodulated signals and the reference amplitude signals; and
a second correlator that correlates the frequency-demodulated signals and the reference frequency signals;
wherein said apparatus measures said time difference based on the correlation results in said correlators.

18. A synchronization apparatus which comprises:
an amplitude demodulator for amplitude demodulation of input signals and for generating amplitude-demodulated signals that are the amplitude component of the input signals;
a phase demodulator, for phase demodulation of input signals and for generating phase-demodulated signals that are the phase component of the input signals;
a signal generator that generates reference amplitude signals and reference phase signals that correspond to the input signals and synchronize with one another;
a first correlator that correlates the amplitude-demodulated signals and the reference amplitude signals;
a second correlator that correlates the phase-demodulated signals and the reference phase signals;
a measuring device that obtains the time difference between the amplitude-demodulated signals and the phase-demodulated signals based on the correlation results in the first and the second correlators; and
a time position tuning device that individually tuning the time position of the amplitude-demodulated signals and/or the phase-demodulated signals based on the time difference.

19. The synchronization apparatus according to claim 18, wherein said time position tuning device individually adjusts the time position of the amplitude-demodulated signals and/or the phase-demodulated signals such that the time position of the amplitude-demodulated signals and the phase-demodulated signals is the same.

20. A synchronization apparatus comprising:
a demodulator that demodulates input signals by 2 or more different N number of demodulation systems and for obtaining N number of demodulated signals;
a signal generator that generates N number of reference signals, which correspond to the respective demodulated signals and the input signals;
a correlator that correlates the demodulated signals and corresponding reference signals and obtaining N number of correlation results; and
a time position tuner that tunes N number of demodulated signals to the same time position based on the N number of correlation results.
